(19) United States
(12) Patent Application Publication
(10) Pub. No.: US 2012/0214539 A1
(43) Pub. Date: Aug. 23, 2012

(54) Method and Device for Adjusting an Uplink Transmission Power of a Mobile Terminal

(76) Inventor: Juergen Michel, Munich (DE)

(21) Appl. No.: 13/504,518

(22) PCT Filed: Oct. 29, 2009
(86) PCT No.: PCT/EP2009/064320

§ 371 Date: Apr. 27, 2012

(51) Int. Cl. H04W 52/14

(52) U.S. Cl. 455/522

(57) ABSTRACT

A method and a device are provided for adjusting an uplink transmission power of a mobile terminal towards a local wireless node that is deployed within a wide area wireless network, wherein at least one power control parameter is determined by the local wireless node from at least one cell of the wide area wireless network; and wherein the uplink transmission power of the mobile terminal is set based on the at least one power control parameter.

The invention relates to a method and to a device for adjusting an uplink transmission power of a mobile terminal towards a local wireless network, wherein the local wireless network is (at least partially) deployed within the wide area wireless network.

The invention in particular relates to the field of mobile wireless communications, e.g., 3GPP Long-Term Evolution (LTE or LTE-A).

A femto cell is a type of base station that may be deployed inside a coverage area of a typical (macro) base station (e.g., an LTE eNB) of a wireless network (which is also referred to herein as wide area cell). The femto cell may have a reduced maximum transmit power compared to the wide area cell and may typically be used indoor, e.g., to cover private residences or public areas (e.g., offices). The femto cell is also referred to as home base station or home eNB and may be abbreviated hereinafter as HeNB.

The femto cell may be deployed and maintained by a customer, hence the exact location of the femto cell deployment is usually not known to an operator. Accordingly, the deployments of such femto cells cannot be planned and appropriately considered by the operator. The number of femto cells that may be operated within the area of a macro cell may be large and a centralized OAM (Operation And Maintenance) scheme may be difficult to provide for all such femto cells.

The customers may also want to ensure for themselves that a sufficient amount of resources are available at their femto cells and protect them from unwanted access. Hence, a customer may configure a closed subscriber group (CSG), wherein a list of authorized subscribers, which are entitled to obtain access to this femto cell are defined. An arbitrary mobile terminal (e.g., UE) may not be allowed connecting to this femto cell because of the CSG (to which it is not a member), although the femto cell would provide the best radio conditions for this mobile terminal. Hence, the CSG scheme may deteriorate the overall performance of the network as it may significantly increase interference.

To utilize the spectrum as efficiently as possible, a co-channel deployment of low power (local) nodes (e.g., HeNBs) and wide area cells (eNBs) is regarded an important scenario in 3GPP standardization. In LTE and/or LTE-A all transmissions within one cell are planned to be orthogonal. Hence, in an ideal case, there is no interference between users (e.g., UEs) that are connected to the same eNB. The only interference that has to be taken into account stems from transmission of users that are connected to adjacent eNBs, which are scheduled to use the same frequency resources.

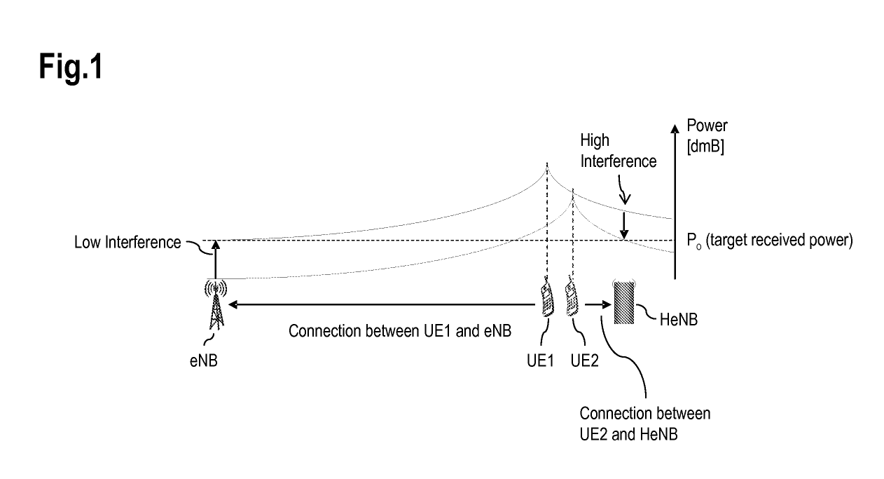

In case of low power femto cells with a co-channel wide area network overlay, interference is a serious issue. In particular with regard to an uplink connection, the local user and the wide area user both can be affected. A user connected to a femto cell may normally have lower path loss to the serving base station and may utilize a lower transmission power than a user connected to a wide area cell (eNB). Accordingly, an interference generated by the local user at the wide area eNB may be less than an interference generated by wide area users perceived at the femto cell. Correspondingly, FIG. 1 shows a schematic diagram visualizing an uplink interference propagation in case of a wide area eNB and a femto cell co-existence.

Utilizing a CSG configuration at the femto cell, a user may not be allowed connecting to the femto cell and thus has to connect with a high transmission power to a far-off wide area cell (eNB) thereby generating a significant amount of interference for the nearby femto cell. If, on the other hand, the uplink power setting for users of the femto cell is too high, the wide area cell users are suffering by experiencing a high degree of interference.

The problem to be solved is to provide an efficient approach to reduce interference between users of a femto cell and users of a wide area base station.

This problem is solved according to the features of the independent claims. Further embodiments result from the depending claims.

In order to overcome this problem, a method is provided for adjusting an uplink transmission power of a mobile terminal towards a local wireless node that is deployed within a wide area wireless network,

wherein at least one power control parameter is determined by the local wireless node from at least one cell of the wide area wireless network;

wherein the uplink transmission power of the mobile terminal is set based on the at least one power control parameter.

The at least one power control parameter may be determined by simply receiving it from the at least one cell of the wide area wireless network. The at least one power control parameter may be derived from a content received from the at least one cell of the wide area wireless network.

It is noted that the at least one cell of the wide area wireless network may be the cell providing the strongest signal among the cells of the wide area wireless network.

The local wireless node is deployed in the coverage of at least one wide area wireless network. The wide area wireless network may be supplied by at least one base station, e.g., an eNB. The wide area wireless network may be the result of a network planning of an operator. The operator may in particular be aware of the locations of the base stations of the wide area wireless network.

The uplink transmission power for the mobile terminal can be determined and conveyed to the mobile terminal. This mobile terminal utilizes a connection to the local wireless node.

Advantageously, this approach allows reducing an interference from a mobile terminal that is connected to the local wireless node within the coverage area of a wide area wireless network.

It is noted that the mobile terminal may be any device with a wireless interface to communicate with the mobile network. Such device may be a cellular phone, a (laptop) computer, a handheld device (e.g., personal digital assistant), a car with a mobile interface or the like. The mobile terminal is also referred to as user equipment (UE).

This approach advantageously allows for an automated configuration and interference reduction in case of an overlapping wide area cell and local wireless node (e.g., femto cell, home base station, HeNB) co-channel deployment.

The solution, however, is not limited to femto cells, but could be applied to any low power (local) node (e.g., wireless base station) that may be deployed within a wide area network that is at least partially operated on the same frequency as is the local wireless node.

In an embodiment, the uplink power for a mobile terminal is a maximal transmission power of the mobile terminal.

Hence, setting the maximal transmission power of the mobile terminal limits the interference with the cells of the wide area wireless network.

In a further embodiment, the at least one power control parameter is determined by the local wireless node by mimicking a mobile terminal.

Hence, the local wireless node may comprise a receiver of the same type as does the mobile terminal in order to obtain signals from the wide area wireless network as a conventional mobile terminal. These signals are used to determine a (maximal) transmission power of the mobile terminal that is (to be) connected to the local wireless node.

In a next embodiment, the at least one power control parameter depends on a parameter indicating a quality of a signal for the local wireless node being connected to a cell providing the strongest signal among the cells of the wide area wireless network.

Hence, the local wireless node may determine the cell providing the strongest signal and then the quality of this signal versus the uplink target quality of this cell may be assessed by the local wireless node.

It is noted that the quality of the signal can be an SINR value, in particular an averaged SINR value.

It is also an embodiment that the at least one power control parameter depends on a parameter indicating a path loss between the local wireless node and the cell providing the strongest signal among the cells of the wide area wireless network.

According to a further embodiment, the at least one power control parameter depends on a parameter indicating a fraction of the path loss to be utilized.

Pursuant to another embodiment, the transmission power is determined based on resources scheduled for the mobile terminal.

The amount of resources required by or for the mobile terminal may have an impact on the transmission power for this particular mobile terminal. For example, a mobile terminal with extensive resources may be allowed a higher transmission power compared to a mobile terminal that requires less resources.

According to an embodiment, the transmission power is determined based on a delta value, which reduces the uplink transmission power by a predefined value.

This predefined value may be set by an operation and maintenance entity. Advantageously, the uplink transmission power of the mobile terminal towards the local wireless node can hence be limited in particular to a value less than an uplink transmission power to a cell of the wide area wireless network. This efficiently reduces interference from the mobile terminal towards the wide area wireless network when being connected to the local wireless node.

According to another embodiment, the uplink transmission power of the mobile terminal is set by the local wireless node via a point-to-point connection towards the mobile terminal.

In yet another embodiment, the uplink transmission power of several mobile terminals is set by the local wireless node via a point-to-multipoint connection towards several mobile terminals.

For example, the at least one power control parameter can be broadcast towards the several mobile terminals via a broadcast channel of the local wireless node.

It is noted that the uplink transmission power of the mobile terminal is set by conveying or signaling power control parameters to the mobile terminal.

According to a next embodiment, a cell of the wide area wireless network is identified based on a transmission power that reaches or exceeds a predefined threshold.

Hence, a mobile terminal may recognize a cell of the wide area wireless network and may distinguish such cell from a local wireless node. The predefined threshold may be set statically or dynamically.

According to a next embodiment, a cell of the wide area wireless network is identified based on a downlink scrambling sequence.

Hence, the downlink scrambling sequence can be utilized in order to identify the cell to be part of the wide area wireless network.

The downlink scrambling sequence may be an element of a pool of predefined downlink scrambling sequences to be used in the wide area wireless network.

Hence, the mobile terminal may recognize a cell of the wide area wireless network and may distinguish such cell from a local wireless node. The predefined pool of sequences for wide area cell usage may be set statically or dynamically.

Pursuant to yet an embodiment, wherein the local wireless node is a Home eNodeB.

The local wireless node may also be referred to as, e.g., femto cell, HeNB or home base station.

According to a further embodiment, the wide area wireless network is an LTE network or an LTE-A network.

However, the wide area wireless network may also be or comprise any wireless network, based on, e.g., 2G, 2.5G, 3G, or other upcoming standards.

It is also an embodiment that the mobile terminal is a user equipment (UE).

The UE can also be regarded as mobile terminal; in addition, the UE mentioned herein also refers to a mobile terminal.

The problem stated above is also solved by a device being deployed within a wide area wireless network, comprising or being associated with a processing unit that is arranged

for determining at least one power control parameter from at least one cell of the wide area wireless network;

for setting an uplink transmission power of the mobile terminal based on the at least one power control parameter.

The setting or adjustment of the uplink transmission power may be applicable for one mobile terminal or for several mobile terminals.

It is noted that the steps of the method stated herein may be executable on this processing unit as well.

It is further noted that said processing unit can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

Pursuant to yet an embodiment, the device is a network element, in particular a node of a wireless communication network, a local wireless node and/or a home base station (HeNB, femto cell).

The problem stated supra is further solved by a communication system comprising at least one device as described herein.

Embodiments of the invention are shown and illustrated in the following figure:

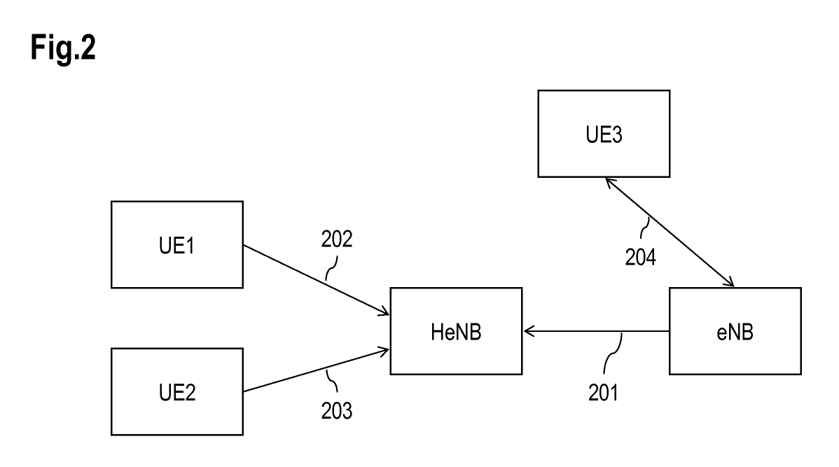

FIG. 2 shows a schematic block diagram comprising an architecture that allows mobile terminals to be connected to a home base station thereby reducing an interference throughout the wide area wireless network.

The approach presented herein in particular provides suitable radio conditions for wide area users as well as femto users by utilizing, e.g., an adaptive uplink power control scheme.
An LTE uplink power control mechanism is described in 3GPP TS 36.213, wherein each base station controls the transmission power of the users connected to it, based on:
   An eNB to UE path loss estimate calculated by the UE;
   Parameters provided from higher network layers.

The transmission power may be determined as follows:

Pₜₓ=min{Pₘₐₓ, Pₒ+α*PL++10*log₁₀M+Δ_{MCS}+f(Δᵢ)}, (1)

wherein

Pₘₐₓ indicates a maximal UE transmission power;

Pₒ is a parameter relating to an averaged received SINR;

α is a path loss compensation factor;

PL indicates a downlink eNB to UE path loss estimate determined by the UE;

M is a number of resources scheduled for a particular UE;

Δ_{MCS} indicates a user specific MSC-dependent correction value;

f(Δᵢ) indicates a user specific correction value.

The parameters with the highest impact on the overall power setting are Pₒ and α. Equation (1) may be suitable in case of a coordinated or planned deployment of base stations, i.e. in a scenario where the eNB positions are placed according to a result of a network planning process. An optimization or fine-tuning of the base stations can be achieved by setting the power control parameters for a suitable cell capacity and/or coverage based in particular on the site locations.

However, with regard to an uncoordinated deployment, e.g., a deployment of femto cells by individual home users within the wide area cell (eNB), the operator is most likely unaware of the exact location of the femto cells. In addition, an indoor and/or outdoor penetration loss of the signals of the femto cells is unknown in particular as the femto cells are typically deployed indoor. Hence, it is not possible to apply optimal power control parameters a priori. Furthermore, the location of the femto cell may change over time (the user may decide to position it at different locations).

This issue can in particular be solved by appropriately utilizing adaptive power control parameters. Hence, the femto cell may set the power control parameters Pₒ and a autonomously (also referred to as P_{o, LA} and α_{LA}). However, a maximum allowed transmit power of a mobile terminal (UE) connected to a femto cell (HeNB) in above power control rule according to equation (1) may depend on the wide area power control parameters of the strongest received wide area cell and the path loss between the femto cell (HeNB) and this strongest received wide area cell.

Interference between local femto cells and wide area base stations, which are deployed in an overlay manner (i.e. there may be several femto cells within a cell of a wide area base station), wherein the local femto cells may be deployed highly decentralized, e.g., by individual users according to their particular requirements, is reduced by modifying an existing uplink power control scheme (of LTE or LTE-A):

(a) The wide area uplink power control is operated based on the specification as set forth for LTE(−A) in 3GPP TS 36.213:

Pₜₓ=min{P_{Max}, P_{o, WA}+α_{WA}*PL_{WA}++10*log₁₀M+Δ_{MCS, WA}+f_{WA}(Δᵢ)} (2),

wherein

P_{Max} indicates the maximal UE transmission power;

P_{o, WA} is a parameter relating to an averaged received SINR for the UE connected to the wide area (WA) cell;

α_{WA} is a path loss compensation factor for the UE connected to the WA cell;

PL_{WA} indicates a downlink eNB to UE path loss estimate determined by the UE that is connected to the WA cell;

M is a number of resources scheduled for the considered UE;

Δ_{MCS, WA} indicates a user specific MSC-dependent correction value for the UE connected to the WA cell;

f_{WA}(Δᵢ) indicates a user specific correction value (used in the wide area cell).

It is noted that the setting of the wide area parameters depend on the wide area deployment.

(b) The local area UL power control is operated based on the specification as set forth for LTE(−A) in 3GPP TS 36.213:

Pₜₓ=min{P_{Max, LA}, P_{o, LA}+α_{LA}*PL_{LA}++10*log₁₀M+Δ_{MCS, LA}+f_{LA}(Δᵢ)} (3),

wherein

P_{Max, LA} indicates a maximal UE transmission power if the UE is connected to the local area (LA) cell (femto cell);

P_{o, LA} is a parameter related to an averaged received SINR for the UE connected to the local area cell;

α_{LA} is a path loss compensation factor for UE connected to the local area cell;

PL_{LA} indicates a downlink eNB to UE path loss estimate determined by the UE that is connected to the local area cell;

M is a number of resources scheduled for the considered UE;

Δ_{MCS, LA} indicates a user specific MSC-dependent correction value for the UE connected to the local area cell;

f_{LA}(Δᵢ) indicates a user specific correction value (used in the local area cell).

It is noted that the maximum UE power setting depends on the equation described under (c) below.

It is further noted that the setting of the local area parameters may mainly depend upon the actual local area deployment.

(c) The maximal UE transmission power if the UE is connected to the local area cell P_{Max, LA} according to equation (3) is determined as follows:

P_{Max, LA}=min{P_{Max}, P_{o, WA}+α_{WA}*PL_{WA, LA}++10*log₁₀M−D} (4)

wherein

P_{Max} indicates a maximal UE transmission power;

P_{o, WA} is a parameter related to an averaged received SINR if the HeNB mimics a UE and is connected to the strongest WA cell;

α_{WA} is a path loss compensation factor used if the HeNB UE type receiver is connected to the strongest WA cell;

PL_{WA, LA} indicates a downlink eNB to HeNB path loss estimate of the HeNB UE type receiver;

M is a number of resources scheduled for the considered local area UE;

D is a delta value, that can be set by an operation and maintenance entity or by higher layers, e.g., an information broadcast via an overlay wide area broadcast control channel.

“HeNB mimics a UE” refers to the fact that the local area cell (femto cell) acts as a UE and obtains said parameters and/or values P_{o, WA}, α_{WA}, PL_{WA, LA} from the WA cell (e.g., eNB). In other words, the LA cell receives in downlink direction (from the WA cell) the parameters and/or values as if it was a mobile terminal (UE). Furthermore, depending on the resources to be scheduled for the mobile terminal (indicated by said parameter M), the maximal UE transmission power can be set up, wherein said delta value D is typically used to avoid that a mobile terminal being connected to the LA cell produces less interference than being connected to the WA cell.

The LA cell may set up the maximal UE transmission power for each mobile terminal separately (point-to-point configuration between the LA cell and the mobile terminal).

As an alternative or in combination, the LA cell may set up the maximal UE transmission power to several mobile terminals (point-to-multipoint) via a broadcast on a LA cell's broadcast channel. This could be achieved utilizing the following steps:

i) A Parameter A can be determined at the LA cell (HeNB) using the receiver of the LA cell in downlink direction; said receiver is in particular a UE-type receiver for FDD:

A=P_{o, WA}+α_{WA}*PL_{WA, LA}−D (5).

ii) The parameter A can be broadcast via a HeNB broadcast control) channel to several mobile terminals.

iii) The maximal UE transmission power P_{Max, LA} for the UE being connected to the local area cell (as described in (b)) can be determined as follows:

P_{Max, LA}=min{P_{Max}, A+10*log₁₀M} (6).

iv) The parameter M depends on the number of resources scheduled by a point-to-point signalling for the considered local area UE.

### Further Advantages

The approach suggested solves the interference problems of overlay networks in uplink direction. Further, local area power control parameters can be set independently from parameters of a wide area cell; hence, the local area control parameters can be optimized with regard to the local area deployment.

Also, the solution provided can be processed in a decentralized autonomous way and does not require an optimization of a huge amount of single femto cells within the wide area cell. This is a significant advantage as a vast number of such femto cells are expected to become activated within the wide area cell.

FIG. 2 shows a schematic block diagram comprising an architecture that allows mobile terminals to be connected to a home base station thereby reducing an interference throughout the wide area wireless network.

In FIG. 2, a local wireless node HeNB is shown that obtains at least one power control parameter 201 from a cell eNB of a wide area wireless network, e.g., an LTE or LTE-A network. This is achieved by local wireless node HeNB mimicking the role of a usual mobile terminal. The power control parameters obtained by the local wireless node HeNB are processed to determine an uplink transmission power for mobile terminals UE1 and UE2. This uplink transmission power could be conveyed to said mobile terminals UE1 and UE2 via a point-to-point communication or via a point-to-multipoint communication. The mobile terminals UE1 and UE2 then utilize an uplink transmission 202, 203 with a maximal power as has been determined by the local wireless node HeNB.

It is noted that the cell eNB of the wide area wireless network may be the cell among several cells providing the strongest signal to the local wireless node HeNB.

Furthermore, the local wireless node HeNB may set the maximal uplink transmission power of the mobile terminals UE1 and UE2 in combination with individual parameters used by the mobile terminals UE1, UE2. Such a parameter may be the aforementioned parameter M indicating scheduled resources for (each mobile terminal UE1, UE2), which are typically different for UE1 and UE2. In addition, an operation and maintenance unit may indicate a delta value D (see also above) to determine a deduction of the maximal transmission power of the mobile terminals UE1, UE2 when being connected to the local wireless node HeNB. Hence, the maximal transmission power of a mobile terminal UE3, which is connected (see connection 204) to the cell eNB of the wide area wireless network may not have such deduction.

It is noted that the cell eNB may control a number of resources the mobile terminal is allowed to use for uplink transmission. The parameter M may be conveyed towards the local wireless node HeNB by the cell eNB; however, there may be an individual parameter for each UE.

It is noted that the block structure shown in FIG. 2 could be implemented by a person skilled in the art as various physical units, wherein local wireless node HeNB could be realized as at least one logical entity that may be deployed as program code, e.g., software and/or firmware, running on a processing unit, e.g., a computer, microcontroller, ASIC, FPGA and/or any other logic device.

The functionality described herein may be based on an existing base station (HeNB), which is extended by means of software and/or hardware.

The local wireless node HeNB may comprise at least one physical or logical processing unit that is arranged for determining at least one power control parameter from at least one cell of the wide area wireless network and for setting an uplink transmission power of the mobile terminal based on the at least one power control parameter.

### LIST OF ABBREVIATIONS

3GPP Third Generation Partnership Project

CSG Closed Subscriber Group

eNB evolved NodeB (base station)

HeNB Home NodeB (home base station or home evolved NodeB)

LA Local Area

LTE Long Term Evolution

LTE-A LTE-Advanced

MCS Modulation and Coding Scheme

SINR Signal to Noise an Interference Ratio

UE User Equipment (mobile terminal)

UL Uplink

WA Wide Area

1. A method for adjusting an uplink transmission power of a mobile terminal towards a local wireless node that is deployed within a wide area wireless network,
wherein at least one power control parameter is determined by the local wireless node from at least one cell of the wide area wireless network;
wherein the uplink transmission power of the mobile terminal is set based on the at least one power control parameter.

2. The method according to claim 1, wherein the uplink power for a mobile terminal is a maximal transmission power of the mobile terminal.

3. The method according to claim 1, wherein the at least one power control parameter is determined by the local wireless node by mimicking a mobile terminal.

4. The method according to claim 1, wherein the at least one power control parameter depends on a parameter indicating a quality of a signal for the local wireless node being connected to a cell providing the strongest signal among the cells of the wide area wireless network.

5. The method according to claim 4, wherein the at least one power control parameter depends on a parameter indicating a path loss between the local wireless node and the cell providing the strongest signal among the cells of the wide area wireless network.

6. The method according to claim 5, wherein the at least one power control parameter depends on a parameter indicating a fraction of the path loss to be utilized.

7. The method according to claim 1, wherein the transmission power is determined based on resources scheduled for the mobile terminal.

8. The method according to claim 1, wherein the transmission power is determined based on a delta value, which reduces the uplink transmission power by a predefined value.

9. The method according to claim 1, wherein the uplink transmission power of the mobile terminal is set by the local wireless node via a point-to-point connection towards the mobile terminal.

10. The method according to claim 1, wherein the uplink transmission power of several mobile terminals is set by the local wireless node via a point-to-multipoint connection towards several mobile terminals.

11. The method according to claim 1, wherein a cell of the wide area wireless network is identified based on a transmission power that reaches or exceeds a predefined threshold.

12. The method according to claim 1, wherein a cell of the wide area wireless network is identified based on a downlink scrambling sequence.

13. The method according to claim 1, wherein the local wireless node is a Home eNodeB.

14. A device being deployed within a wide area wireless network, comprising or being associated with a processing unit that is arranged
for determining at least one power control parameter from at least one cell of the wide area wireless network;
for setting an uplink transmission power of the mobile terminal based on the at least one power control parameter.

15. The device of claim 14, wherein said device is a local wireless node, in particular a home base station.
